(19) United States
(12) Patent Application Publication
(10) Pub. No.: US 2024/0372112 A1
(43) Pub. Date: Nov. 7, 2024

(54) AMBIENT TEMPERATURE LIQUID METAL AIR FLOW BATTERY

(71) Applicant: Worcester Polytechnic Institute, Worcester, MA (US)

(72) Inventors: Andrew R. Teixeira, Boylston, MA (US); Ravindra Datta, Worcester, MA (US); Pratap Rao, Northborough, MA (US); Ari Athair, Port Angeles, WA (US); Cameron Armstrong, Hopkinton, MA (US); Muntasir Shahabuddin, Worcester, MA (US)

(21) Appl. No.: 18/654,330

(22) Filed: May 3, 2024

Related U.S. Application Data
(60) Provisional application No. 63/463,666, filed on May 3, 2023.

(51) Int. Cl. H01M 4/90; H01M 4/86; H01M 8/18; H01M 50/497

(52) U.S. Cl. CPC H01M 4/9091; H01M 4/9016; H01M 4/9041; H01M 8/188; H01M 50/497; H01M 2004/8684; H01M 2004/8689; H01M 2300/0002

(57) ABSTRACT

A low temperature, liquid metal approach provides a metal-air battery at room temperature or slightly above for high current density, using ambient oxygen as an electrode without the need for high heat for an opposed metal electrode. A metal-air battery employs a low melting point metal such as gallium for an all-fluid battery having a flowing aqueous electrolyte for maintaining a large volume of electrical storage capacity separate form a relatively small reactor or cell for powering an electrical load. Reversibility of the forward discharge (load powering) reaction provides a recharging capability well suited for grid storage to moderate supply and demand variations. The result is an ultra-high density, rechargeable, safe, grid-scale electricity storage technology as an alternative to lithium-ion and solvent-based flow batteries.

### RELATED APPLICATIONS

This patent application claims the benefit under 35 U.S.C. § 119(e) of U.S. Provisional Patent App. No. 63/463,666, filed May 3, 2023, entitled “AMBIENT TEMPERATURE LIQUID METAL AIR FLOW BATTERY,” incorporated herein by reference in entirety.

### STATEMENT OF FEDERALLY SPONSORED RESEARCH AND DEVELOPMENT

This invention was made with government support under grant No. 2038257, awarded by the National Science Foundation. The Government has certain rights in the invention.

### BACKGROUND

Electrical energy for human use has been a staple of existence in industrialized nations for over 100 years. After initial maturation over AC (alternating current) vs. DC (direct current), voltage ranges and transmission lines for delivery, the modern electric grid evolved and has been based on the same principle technology for decades. This vast network delivers reliable AC power at standard voltage levels of 120-240V AC single phase at 60 Hz for most residential consumers and three-phase for business applications, and save for infrequent outages from inclement weather, is generally an uninterrupted convenience of modern life.

With the onset of renewable energy presenting challenges of intermittent generation, attention has been focused on an ability to store electric power on a grid-scale to create a more resilient electrical grid. In contrast to EVs (electric vehicles), grid scale storage is sought without lithium for supply chain and efficiency reasons. Such grid scale storage technology ideally can be assimilated for reliable, grid-scale alternatives to lithium ion batteries. Some conventional approaches are using reversible aqueous or solvent-based chemistries in flow batteries (e.g. vanadium, or liquid metal batteries at high temperatures (>500 C).

### SUMMARY

A low temperature, liquid metal approach provides a metal-air battery at room temperature or slightly above for high current density, using ambient oxygen as an electrode without the need for high heat for an opposed metal electrode. The metal-air battery employs a low melting point metal such as gallium for an all-fluid battery having a flowing aqueous electrolyte for maintaining a large volume of electrical storage capacity separate form a relatively small reactor or cell for powering an electrical load. Reversibility of the forward discharge (load powering) reaction provides a recharging capability well suited for grid storage to moderate supply and demand variations. The result is an ultra-high density, rechargeable, safe, grid-scale electricity storage technology as an alternative to lithium-ion and solvent-based flow batteries.

Configurations herein are based, in part, on the observation that grid storage mediums are sought for accommodating electrical supply variances presented by environmentally favorable alternative to fossil fuel electrical generation. So-called “green” alternatives such as solar, wind and ocean currents can be intermittent and may need to be accompanied by substantial storage capacity for viable grid alternatives. Unfortunately, conventional approaches to stationary, grid-scale storage suffer from the shortcoming of low storage density, use of volatile electrolytes, and/or high temperature molten metal electrodes. Reversibility of the forward, current generating electrochemical reaction is also needed for a rechargeable (secondary) storage medium viable for grid storage. Accordingly, configurations herein substantially overcome the shortcomings of conventional lithium alternatives to electric storage by providing a rechargeable, room temperature metal-air battery (MABs) to provide extremely high energy density using a reversible oxidation/reduction chemistry for rechargeability amenable to grid storage.

In further detail, configurations herein provide a metal-air battery having an electrode defined by gaseous oxygen, and an opposed electrode defined by a liquid metal at an ambient room temperature. The opposed electrode is responsive to oxidation for generating a current discharge flow, and an electrolyte allows for ion diffusion including oxygen to the opposed electrode. The liquid metal may be fulfilled by gallium.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic diagram of a flow battery device suitable for use with low ambient temperature, rechargeable operation as disclosed herein;

FIG. 2 is a schematic of the rechargeability/secondary battery capability as in the device of FIG. 1;

FIG. 3 is an exploded view of a configuration for demonstrating rechargeability based on the schematic of FIG. 1;

FIGS. 4A and 4B show test results establishing rechargeability of the battery configuration as in FIGS. 1-3.

### DETAILED DESCRIPTION

The description below presents an example of methods for configurations including a secondary metal-air battery using liquid gallium for near room temperature (around 30° C., or 80° F.) operation.

Despite their energy density, broad applications, and low cost, metal-air batteries (MABs) beyond Zn-air, popular with conventional hearing aids, still need to overcome a number of technological and cost challenges before realizing commercial success as energy storage devices, including the metal costs, inadvertent corrosion/passivation, and low redox potential causing low Faradaic efficiency. Further, MABs have not yet been configured as true flow batteries since solid metal is usually confined to the negative electrode. This means that all MABs scale as conventional batteries, requiring power and capacity to be coupled. If a liquid metal could be employed under near ambient conditions, a true flow MAB could be developed for a number of applications, including easily refueled EVs and long-duration energy storage.

Configurations herein provide an ambient temperature liquid metal-air battery (LMAB) based on gallium for providing an all-liquid flow battery with an unprecedented energy density. Cyclic voltammetry results confirm a reversible Ga—Ga₂O₃ redox couple suitable for the negative electrode, with a potential of −0.483 V vs. a reversible hydrogen electrode (RHE) under strongly alkaline conditions. Thus, the resulting cell voltage for the Ga-air battery is 1.72 V, in comparison with 1.67 V for conventional solid Zn-air systems. The gallium LMAB (Liquid Metal-Air Battery) disclosed herein shows superior polarization performance in comparison with a commercial Zn-air battery (ZAB). The LMAB is particularly attractive when coupled with the natural benefits of the liquid state of the metal such as the absence of dendrite formation, self-healing nature, convenient refilling or recharging, and the potential for a true flow MAB with a flexible configuration. Configurations herein demonstrate and overcome a lack of rechargeability in conventional MABs is attributed to the detrimental drying of the thin electrolyte layer at the test temperature of 50° C. A flowing electrolyte, for example, can readily hydrate the thin electrolyte layer to overcome inadvertent drying, and a flow battery configuration can enhance mixing to overcome transport limitations of the oxide at the interface.

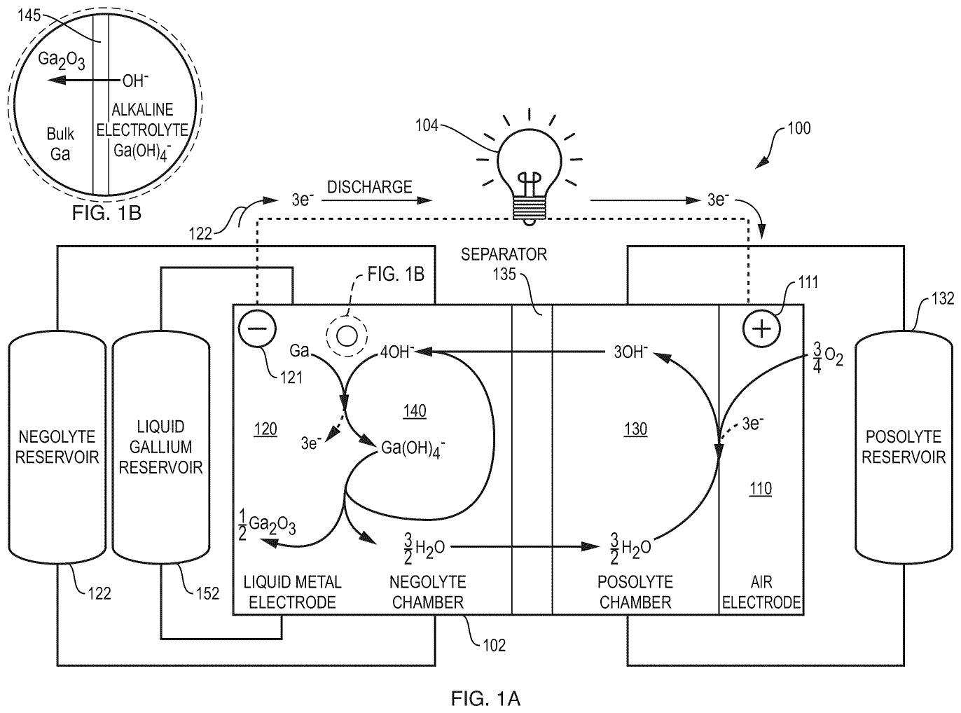

FIG. 1 is a schematic diagram of a flow battery device suitable for use with low ambient temperature, rechargeable operation as disclosed herein. Referring to FIG. 1, a metal-air battery 100 includes an electrode 110 defined by gaseous oxygen, and an opposed electrode 120 defined by a liquid metal at an ambient room temperature. The opposed electrode 120 is responsive to oxidation for generating a current discharge flow 122, as an electrolyte allows for ion diffusion including oxygen to the opposed electrode 120. In the example of FIG. 1, the electrode 110 is atmospheric oxygen defining a positive electrode 111, and the liquid metal defines a negative electrode 121. As indicated above, the negative electrode 121 includes gallium, possibly as an alloy, for low temperature liquid metal flow. Gallium metal has a melting point of 85.58° F. (29.76° C.), thus liquid operation slightly above a typical ambient “room temperature” for human habitation is achievable. No high heat for melting or bringing the metal electrode 120 to a liquid state is required.

The electrolyte, normally defined by a single substance or solvent in conventional batteries, may include at least two substances, a posolyte 130 and a negolyte 140. The electrolyte at the negative (negolyte) electrode 121, and positive (posolyte) electrode 111 may each be stored individually in respective tanks 122, 132, enabling facile reconditioning and maintenance. A pH difference between the posolyte and negolyte facilitates electrochemical charge flow. For generality, separate electrolytes are shown in FIG. 1 for the metal and the air electrodes, although in the typical MAB there may be a common supporting electrolyte, acidic or basic. The ion common to the two electrode reactions is exchanged via the separator, e.g., the OH⁻ ion, involving an anion-exchange membrane (AEM), although it could alternately be a cation, e.g., Na⁺, when a cation-exchange membrane (CEM) is used.

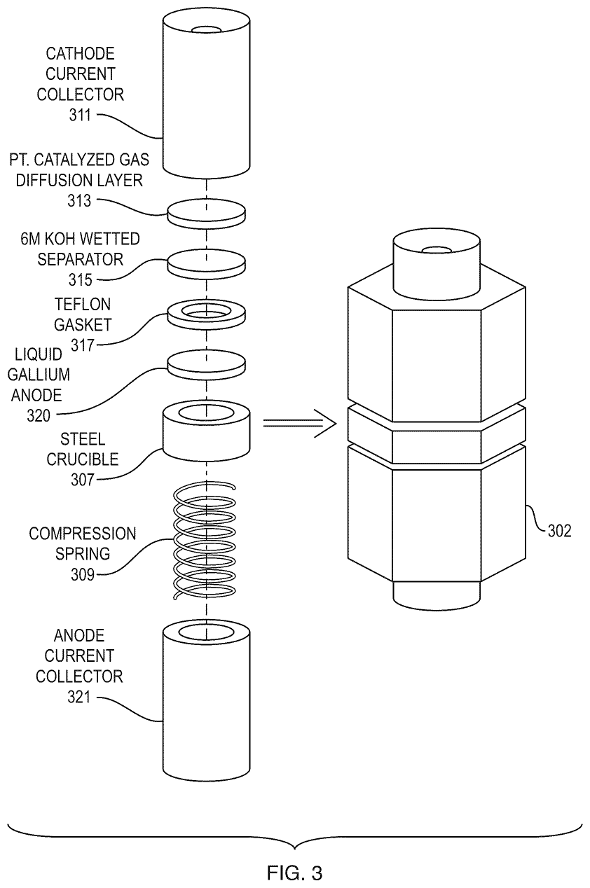

The liquid metal electrode 120 also communicates with a reservoir 152. In the disclosed approach, gallium was chosen because of its low melting point (29.75° C.), stability in air, low toxicity, ease of handling, and the multivalent electrode reaction resulting in a high energy density battery. Thus, the theoretical energy density of a Ga-air battery is 1,989 Wh kg⁻¹, significantly higher than the 2-electron Zn-air battery (1,361 Wh kg⁻¹) because of its 3-electron reaction. Further, the crustal abundance of Ga is similar to that of Li. Because its closest analogue is the Zn-air battery, a comparison is made between the performance of a commercial Zn-air button cell, and a Ga-air button-cell shown in FIG. 3. Since the Ga redox potential of Φ°=−1.323 V, similar to that for Zn (−1.266 V), is substantially lower than that of the Hydrogen Evolution Reaction (HER) at high pH (−0.828 V), electrochemical HER may be expected, along with chemical HER, or corrosion, to an extent similar to that in the Zn-air battery. Alternate configurations may employ other suitable ambient temperature liquid metal eutectics, such as binary or ternary eutectics of Ga with In, Sn, Zn, Cd, Bi, etc., some of which have been employed to quell the HER.

As a practical matter, the battery 100 device of FIG. 1 employs a containment 102. The positive 111 and negative 121 electrodes connect to an electrical load 104 for electrical production via discharge. The containment 102 is also configured for a reversible oxidation/reduction reaction between the electrode and the opposed electrode for recharge, also involving switching the electrodes 111 and 121 for a reverse current flow, as the metal-air battery 100 is responsive to a negative current flow for recharging the metal air battery.

A central benefit of a flowing system as in FIG. 1 is that while power requirements determine the active battery area in the stack, the energy, or the capacity, requirements determine the size of the tanks 152 storing the liquid metal 120 and the electrolytes 122, 132. This further allows active management of these materials to extend the battery life, e.g., reconditioning the negolyte to account for any pH changes and state-of-charge (SOC) imbalance, both caused by hydrogen evolution, or removal of any carbonate formed in the posolyte from air exposure. Another benefit of a flow system is that the effect of passivation in a flowing metal would be lower than that on the surface of a stagnant liquid metal pool, or on solid metal surface due to flow-induced mixing.

It should be apparent that the load 104 represents an electric grid connection and an appropriate recharging connection to suitable generation sources. Within the containment 102, the posolyte 130 is in communication with the atmospheric air for forming the positive electrode 111, and the negolyte 140 is in communication with the opposed electrode for forming the negative electrode 121. A separator 135 between the posolyte 130 and the negolyte 140 is adapted for ion diffusion of hydroxide ions for combining with gallium metal defining the liquid metal electrode 120. A gallium film 145 between the negolyte 140 and the gallium metal 120 is responsive to passing hydroxide ions for forming gallium oxide. Depending on the configuration, the gallium film 145 may include gallium oxide or gallium hydroxide.

The eutectics discussed above, often mixes of Ga—In—Sn, have been deployed in conventional approaches for demonstrating reversibility of batteries employing stagnant gallium, in alkaline soaked and gel electrolytes; but secondary cell formats that have been explored in conventional approaches have not used air cathode chemistries. Conventional MAB formats generally lack rechargeability and do not implement robust thermodynamic and kinetic implications of each reaction, nor the potential of coupling a Ga-air system in flow batteries.

For the gallium-based system shown in FIG. 1, the electrodes, electrolyte, and the overall cell reaction processes written for the discharge mode in a strongly alkaline KOH electrolyte (pH≥14) are described in Table I. This mechanism is based on the proposition that in strongly alkaline and concentrated Ga(III) solutions, monomeric Ga(OH)₄⁻ is the only species present, although at a lower pH a variety of trivalent gallium ions may be present, such as Ga³⁺, Ga(OH)²⁺GaO⁺, GaO₂⁻, Ga(OH)₄⁻, H₂GaO₃⁻, HGaO₃²⁻ and GaO₃³⁻. Furthermore, in the above scheme, we have assumed Ga₂O₃ to be the eventual product, formed as a film on the Ga surface from Ga(OH)₄⁻ in the electrolyte solution. It is assumed that an equilibrium is reached between this surface film of Ga₂O₃ and bulk Ga(OH)₄⁻, which demonstrably does not favor precipitation of Ga₂O₃ to a degree which would significantly limit the dissolution reaction. However, it is possible that the eventual product is instead Ga(OH)₃, when the cell voltage would be V₀°=1.621 V, or indeed a mixture of Ga₂O₃ and Ga(OH)₃, with an intermediate cell voltage. The overall reactions supporting the Ga-air device of FIG. 1 are presented in Table 1:

TABLE I

| Layer | Process | Reaction | Potential (V) | ΔGᵣº(kJ mol⁻¹ |
|---|---|---|---|---|
| +ve | ORR/OER | $\frac{3}{4} {O}_{2} + \frac{3}{2} {H}_{2} O + 3 {e}^{-} ⇄ 3 {OH}^{-} ( a q )$ | Φ₊º = +0.401 | −116.1 |
| −ve | Ga Redox | Ga + 4OH⁻ (aq) [symbol] Ga(OH)₄⁻ (aq) + 3e⁻ | Φ₋º = −1.221 | −353.6 |
| −ve | Ga Redox | $Ga + 3 {OH}^{-} ( aq ) ⇄ \frac{1}{2} {Ga}_{2} {O}_{3} ( s ) + \frac{3}{2} {H}_{2} O + 3 {e}^{-}$ | Φ₋º = −1.323 | −383.1 |
| Negolyte | Dissolution | ${Ga ( OH )}_{4}^{-} ( aq ) ⇄ \frac{1}{2} {Ga}_{2} {O}_{3} ( s ) + \frac{3}{2} {H}_{2} O + {OH}^{-} ( aq )$ | | −29.75 |
| Cell | Overall | $Ga + \frac{3}{4} {O}_{2} ⇄ \frac{1}{2} G {a}_{2} {O}_{3} ( s )$ | V₀^{o} = 1.724 | −499.2 |

During continued anodic oxidation, the OH⁻ ion must diffuse from the bulk electrolyte across any passivating film of the oxidation product, Ga₂O₃ and/or Ga(OH)₃, a few molecules thick on the surface, to react with bulk Ga, as shown in FIG. 1. The passivating layer may be continuously removed by the spontaneous dissolution of the oxide into the electrolyte, which is favored under conditions of dilute Ga(OH)₄²⁻. For charging, the reverse chemical, electrochemical, and transport steps would occur.

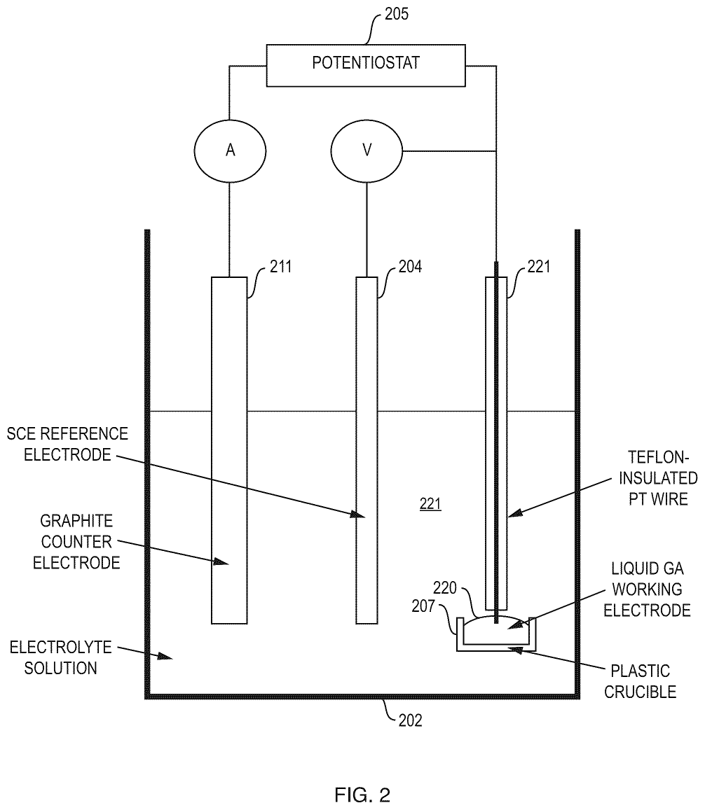

FIG. 2 is a schematic of the rechargeability/secondary battery capability as in the device of FIG. 1. The practical application of rechargeability relies on the ability to perform the reverse reaction for reduction to complement the oxidation reaction for discharge. Reversibility of Ga anode chemistry was investigated through two means: 1) Cyclic Voltammetry (CV) testing of Ga, and 2) a slurry electroplating reduction test of Ga₂O₃ from solution. Because the surface tension of liquid Ga varies dramatically from nearly 7 times that of water to very low surface tensions upon surface oxidation as a voltage is applied, liquid Ga was placed in a small plastic crucible during CV tests so that constant electrical contact and surface area could be maintained, as shown in FIG. 2.

Referring to FIGS. 1 and 2, CV reactions occur in a 33.6 wt. % KOH electrolyte using a potentiostat 205, with a three-electrode cell composed of working, counter, and reference electrodes. The working electrode 220 was composed of 99.999% Ga of ˜1 cm³ volume (0.385 cm² exposed area) and was contained in plastic crucible 207 and contacted by a Teflon-sleeved 99.95% pure Pt electrode 221 of 28-gauge diameter. A counter electrode 211 was a graphite rod of 1 cm diameter contacted by Ni wire and Ag epoxy to reduce contact resistance. An area of the counter electrode 211 was significantly larger than working electrode 220 to overcome any kinetic limitations of the working electrode. The CV results followed the IUPAC convention with anodic current as positive upward and anodic voltage sweep to the right. Current output was divided by 0.385 cm², the approximate area of the exposed portion of gallium and circular area of plastic crucible, to obtain the current density.

Turning for the moment to FIG. 3, FIG. 3 shows an exploded view of a configuration for demonstrating rechargeability based on the schematic of FIG. 1. In FIG. 3, a button cell battery enclosure 302 demonstrates feasibility of the liquid gallium-air battery. FIG. 3 shows the exploded view of a configuration which was inverted during tests to allow for greater contact between the liquid Ga and the electrolyte separators. The cathode 311 and anode 321 current collectors were manufactured from stainless-steel. The stainless-steel crucible 307 holding liquid Ga was machined to the volume of ˜1 cm³. The assembly included a stainless-steel precision compression spring (0.750 in. long, 0.36 in. O.D., 0.026 in. thick wire) 309, and ½ inch PTFE Swagelok tube fitting with corresponding PTFE ferrules, and union body.

Other components included a platinum catalyzed carbon Gas Diffusion Layer (GDL) 313 to facilitate the oxygen reaction, which was a Low Temperature Gas Diffusion Electrode (GDE) microporous layer including 5 g/m² Pt electrode on a woven web. A battery separator 315 used was a Zircar® woven cloth type ZYK-15 (yttria-stabilized Zr), with a thickness of 0.3048 mm (0.012 inches) and a porosity of 85%. In addition, 25 μm thickness, 2500 Celgard polypropylene separators were also tested. The separators were fabricated by using a 1.4 cm diameter hole punch. An electrolyte of 33.6 wt. % KOH was used to prewet the separator 315 prior to assembly. A PTFE gasket 317 with an inner diameter of 0.9 cm and outer diameter of 1.4 cm was used to seal between the layers, making an active cell area of 0.64 cm². The battery cell enclosure 302 was set to ensure an average cell temperature of 50° C., thus maintaining the Ga in its liquid state.

Once the battery enclosure 302 was assembled, tests were conducted using a battery metric analyzer. The tester was controlled for 1 battery cell with a maximum of 1,000 mAh capacity. Discharge tests included a 20 min pause after cell assemble to allow its temperature and the cell to stabilize, followed by a 0.5 mA discharge with a 0.1 V cutoff. A Galvano-staircase polarization curve measured the battery voltage as current was increased from 0 mA to 7.5 mA in 0.1 mA increments every 20 seconds. Thereafter, 0.5 mA increments occurred every 20 seconds, until a current of 15 mA was reached. Then the open circuit voltage was measured again after a 15-minute pause.

Development of the Ga-based LMAB relies on establishing the kinetics as well as the reversibility of the Ga electrode in alkaline media. Reversibility of the electrode reaction during charge depends on the solution concentration of Ga(OH)₄⁻ in the electrolyte.

Continuing to refer to FIG. 1, the Ga surface in alkaline media is usually covered with oxide or hydroxide passive film 145, impeding its further anodic oxidation. The surface layer, comprising of Ga₂O₃ or Ga(OH)₃, can further reduce the surface tension of liquid Ga metal, and hence change its wetting behavior, shape, interfacial area and capacitance, leading to somewhat unreliable electrochemical behavior. In addition, a presence of other ions in solution and the simultaneous hydrogen evolution can inject complexities into the resulting reactions. Configurations herein generalize and depict the electrochemical behavior and reversibility of Ga in an alkaline electrolyte of interest for the LMAB 100.

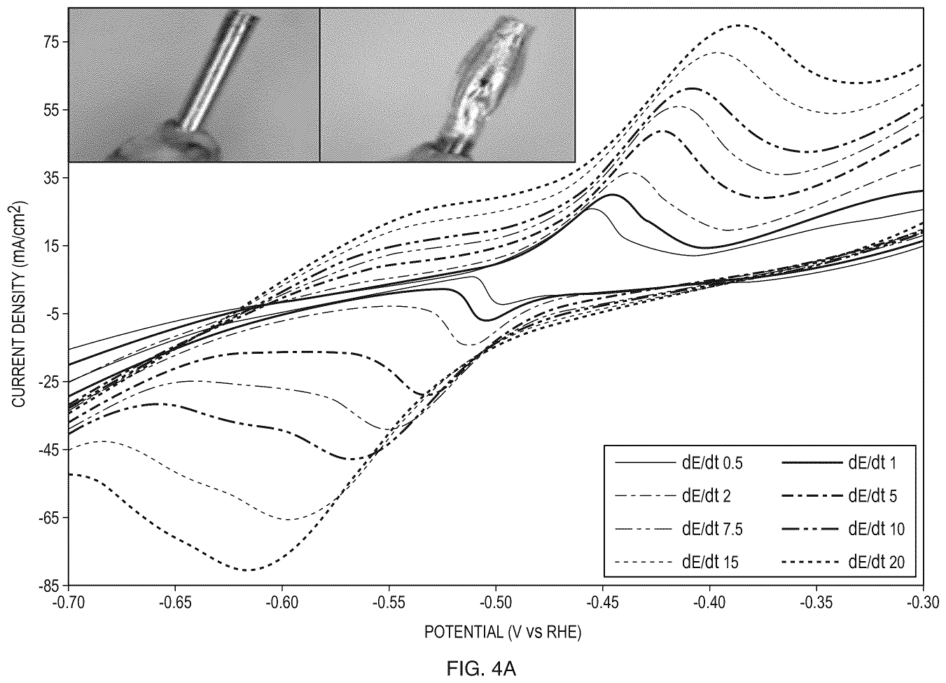

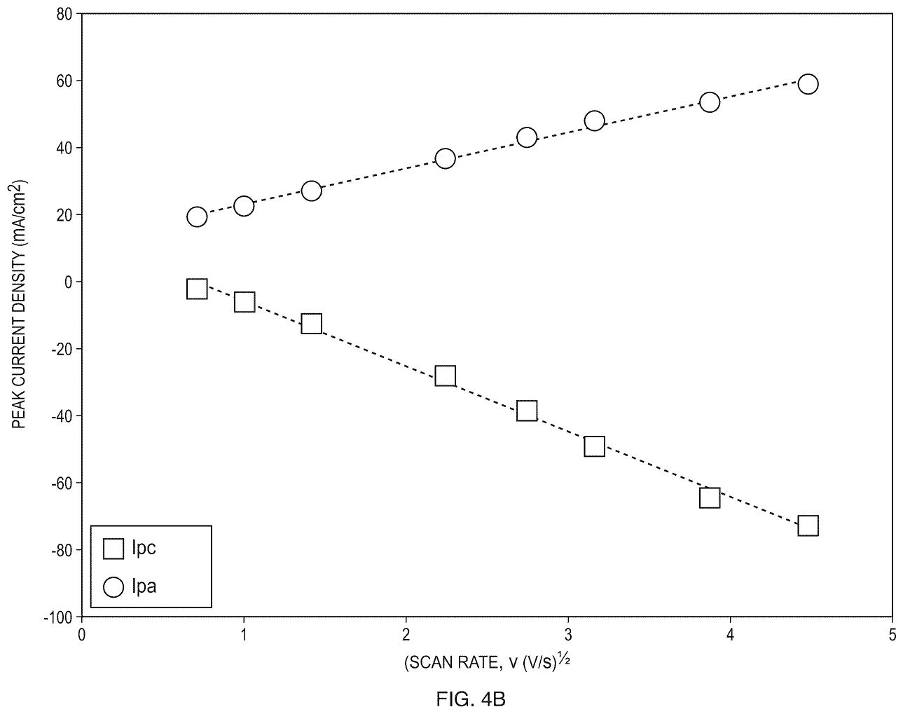

FIGS. 4A and 4B show test results establishing rechargeability of the battery configuration as in FIGS. 1-3. In operations testing, following an initial 100 scanned CV cycles, highly reproducible, reversible curves were obtained. However, as voltage scan rate changed, variability in relative peak height was observed. Low scan rates (0.01 and 0.5V/s) showed almost no reduction peak; however, when scan rate was increased the curve showed a reversible shape. As scan rates increased further, the oxidation peak diminished, and reduction peak grew. At low scan rates, e.g., 0.5V/s the reduction peak was almost non-existent and progressively increased until equal to the oxidation peak, providing a peak current ratio of unity, which is indicative of a reversible reaction.

An observed initial lack of a reduction peak at low scan rates was indicative of high Ga₂O₃ solubility in the aqueous KOH electrolyte, thus dispersing the product away from the metal-electrolyte interface and hence limiting the back reaction. At high scan rates, there is insufficient time for Ga₂O₃ dissolution and diffusion away from the interface, resulting in the reduction reaction and causing the two peaks to be symmetrical. Confirmation is shown by adding Ga₂O₃ to the electrolyte to obtain a saturated solution. Cyclic voltammetry with such a mixture showed a stable and reversible curve shape due to the higher concentrations of reduction reactants in the cell 302 of FIG. 3, confirming that much of the irreversibility is due to dissolution reaction of formed Ga₂O₃ during oxidation in the CV test set up.

Referring to FIGS. 4A and 4B, FIG. 4A shows a voltammogram of Ga+0.1M Ga₂O₃ saturated mixture in 33.6 wt. % KOH after 150 cycles is shown using current density (vertical axis) vs. voltage (horizontal axis). In the inset of FIG. 4A, electrodeposition of Ga₂O₃ from solution onto a Pt electrode is shown. FIG. 4B shows a plot of linear relation between square root of scan rate (horizontal axis) and peak current (vertical axis).

The average mid-peak potential of each scan was −0.4826 V vs. reversible hydrogen electrode (RHE), close to the theoretical −0.485 V vs RHE theoretical value to produce Ga₂O₃. To assess the reversibility of the systems linear plots of peak current density vs. the square root of the scan rate were created to show the fit to the Randles-Sevcik relation:

$$\text{?} {i}_{p} = ( 2.69 \times {10}^{5} ) {n}^{1 / 2} A {C}_{o}^{*} {D}_{o}^{2} {v}^{1 / 2}$$

$$\text{?} \text{indicates text missing or illegible when filed}$$

which shows that the peak anodic (iₚₐ) and cathodic currents (i_{pc}) should vary linearly with the square root of the scan rate (v) for reversible systems. The slope of the resulting straight line is determined by the concentration (Cₒ*), area (A), number of electrons transferred (n), and the reactant diffusion coefficient (Dₒ).

FIG. 4 therefore establishes the relation between peak current and the square root of the scan rate is plotted, and results in linear relationships for iₚₐ and i_{pc} that are indicative of reversibility. The data showed a strong linear relationship, with R² values for the anode and cathode peaks of 0.9514 and 0.994, respectively. The slight difference in slopes shows that oxidation reaction is favored at lower scan rates while the reduction reaction favored at higher rates. The non-zero intercept of this plot is likely due to background current associated with the solvent-electrolyte system which does not affect the peak potentials measured and only creates an additive shift in the peak current density.

The CV testing is consistent with expectations for a reversible electrochemical reaction in that average mid-peak potential does not vary significantly. Furthermore, the peak current ratio is close to unity for different scan rates, and a linear relation between the square root of the scan rate and the peak currents exists. However, the peak position is seen to vary with scan rate, with E_{pc} (related to i_{pc}, lower graphed line in FIG. 4B) becoming more negative and Eₚₐ (related to iₚₐ, upper graphed line in FIG. 4B) becoming more positive with increasing scan rate, thus indicating a quasi-reversible system, i.e., some irreversibility is present. Additionally, Eₚₐ−E_{pc}E_{pc}=59 mV/n matches the peak potential difference obtained at low scan rates; however, at higher scan rates Eₚₐ−E_{pc}>59 mV/n, congruent with a more quasi-reversible system.

Results from CV runs with Ga+Ga₂O₃ show an average formal reduction potential of −0.483 V, close to the Nernst potential of −0.485 V vs RHE for Ga₂O₃, and an average peak current ratio of 1.35 with the smallest coefficient of variability. The reduction of variability when Ga₂O₃ is added to the electrolyte solution is indicative of a diffusional limitation which limits reduction reaction in the tests with only Ga and no Ga₂O₃. Thus, with only Ga, the average reduction potential obtained is −0.463 V vs RHE, peak current ratio of 1.73 with an associated coefficient of variability that is 3.5 times larger than that observed with Ga₂O₃ addition to the electrolyte.

To further demonstrate the reversibility, electrodeposition of Ga was confirmed, when a Pt electrode was placed in a solution of electrolyte saturated with Ga₂O₃ and a current was applied. Successful electrodeposition of liquid Ga can be seen in the FIG. 4 inset, where the picture on the left shows the Pt electrode prior to electrodeposition and the image on the right shows the deposited liquid Ga film on the electrode following a reduction. The volume of deposited Ga was estimated to calculate the coulombic efficiency of the charging process and found to be ˜70%, indicating that ˜30% of the transferred electrons were dissipated through other mechanisms. A steady stream of bubbles was observed at the Pt electrode during the electrodeposition experiments, indicating that H₂ evolution was taking place on Pt due to the low potentials. Of course, the extent of H₂ evolution during an actual liquid-Ga battery operation would likely be lower, as Ga is a much poorer catalyst than Pt.

The collective results of the devices of FIGS. 2 and 3 demonstrate development of developing a low temperature, rechargeable liquid gallium-air battery. A button cell with a zirconia cloth separator soaked in KOH electrolyte, a stainless steel cup with liquid Ga as the anode, and a Pt catalyzed gas diffusion layer cathode demonstrate a discharge performance similar to a commercial Zn-air button cell, as commonly used in primary batteries such as for hearing aids. Cyclic voltammetry results showed that the addition of Ga₂O₃ to the aqueous electrolyte increased the reversibility of the gallium oxidation reaction, which at low concentrations is limited by the transport of Ga₂O₃ from the bulk liquid to the metal surface. However, recharging of the button cell battery configuration of FIG. 3 can be challenged by drying of the thin electrolyte film employed in the cell, which can be overcome by developing a system with a flowing electrolyte, as in FIG. 1. The disclosed ambient temperature liquid metal air battery therefore provides for a high energy density battery with applications in flexible electronics, transportation, and energy storage.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A metal-air battery, comprising:
an electrode defined by gaseous oxygen;
an opposed electrode defined by a liquid metal at an ambient room temperature, the opposed electrode responsive to oxidation for generating a current discharge flow; and
an electrolyte for ion diffusion including oxygen to the opposed electrode.

2. The device of claim 1 wherein:
the electrode is atmospheric oxygen defining a positive electrode; and
the liquid metal defines a negative electrode.

3. The device of claim 1 wherein the opposed electrode includes gallium defining a negative electrode.

4. The device of claim 1 wherein the electrode defined by gaseous oxygen is a positive electrode.

5. The device of claim 1 wherein the metal-air battery is responsive to a negative current flow for recharging the metal air battery.

6. The device of claim 5 further comprising a containment, the containment configured for a reversible oxidation/reduction reaction between the electrode and the opposed electrode.

7. The device of claim 2 wherein the electrolyte further comprises:
a posolyte in communication with the atmospheric air for forming a positive electrode; and
a negolyte in communication with the opposed electrode for forming a negative electrode; further comprising:
a separator between the posolyte and the negolyte and adapted for ion diffusion of hydroxide ions for combining with gallium metal defining the liquid metal.

8. The device of claim 7 further comprising:
a gallium film between the negolyte and the gallium metal, the gallium film responsive to passing hydroxide ions for forming gallium oxide.

9. The device of claim 8 wherein the gallium film includes gallium oxide or gallium hydroxide.

10. The device of claim 2 wherein the liquid metal is gallium metal, the gallium in communication with the electrolyte for supporting a recharge current flow.

11. The device of claim 1 wherein the liquid metal is at a temperature between 20° C. and 40° C.

12. A method for providing electrical storage in an ambient temperature metal-air battery, comprising:
flowing an electrolyte through a chamber for communication with gaseous oxygen;
flowing a second electrolyte through a second chamber in communication with a liquid metal electrode defined by a liquid metal at an ambient room temperature;
separating the first electrolyte from the second electrolyte by a separator, the separator adapted for ion passage; and
connecting an electrical load for a discharge flow between the liquid metal electrode and an electrode in electrical communication with the gaseous oxygen.

13. The method of claim 12 wherein the oxygen is sourced from atmospheric oxygen defining a positive electrode, such that the liquid metal defines a negative electrode.

14. The method of claim 13 wherein the liquid metal includes gallium.

15. The method of claim 12 further comprising recharging the metal-air battery by connecting a reverse voltage source between the liquid metal electrode and an electrode in electrical communication with the gaseous oxygen.
